(19) United States
(12) Patent Application Publication
(10) Pub. No.: US 2026/0265526 A1
(43) Pub. Date: Sep. 10, 2026

(54) CYANINE PHOTOACID COMPOUNDS CONTAINING NITROGEN HETEROCYCLES FOR REVERSIBLE, EXTERNAL CONTROL OF LOCAL ACIDITY

(71) Applicant: The Government of the United States of America, as represented by the Secretary of the Navy, Arlington, VA (US)

(72) Inventors: Daniel A. Corbin, Washington, DC (US); Christopher J. Breshike, Washington, DC (US); R. Andrew McGill, Washington, DC (US)

(73) Assignee: The Government of the United States of America, as represented by the Secretary of the Navy, Washington, DC (US)

(21) Appl. No.: 19/544,044

(22) Filed: Feb. 19, 2026

Related U.S. Application Data
(60) Provisional application No. 63/767,798, filed on Mar. 6, 2025.
(60) Provisional application No. 63/925,302, filed on Nov. 25, 2025.

(51) Int. Cl. C09B 23/12

(52) U.S. Cl. CPC C09B 23/12

(57) ABSTRACT

This invention relates generally to a new class of dye materials which become more acidic when exposed to light and are referred to as photoacids. This invention relates to compounds which are broadly classified as cyanine dyes, which contain within their structure a functional group with a labile proton such as a protonated nitrogen heterocycle. These cyanine dye photoacids have the general structure:

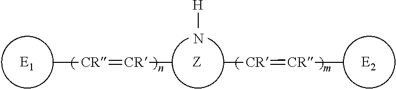

wherein E₁ and E₂ are heterocycles containing at least one heteroatom and one aromatic ring,
wherein Z is a heteroaromatic group in conjugation with the adjacent methine chains,
wherein n and m are integers independently selected from 0 to 4.

Irradiation of these cyanine dye photoacids allows for precise external control of the pH of a solution or the local environment around the dye, with both spatial and temporal resolution achieved by manipulation of the light source.

### REFERENCE TO RELATED APPLICATION

This application is a non-provisional of, and claims priority to and the benefits of, U.S. Provisional Patent Application No. 63/767,798 filed on Mar. 6, 2025, and U.S. Provisional Patent Application No. 63/925,302 filed on Nov. 25, 2025, the entirety of each is herein incorporated by reference.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; techtran@nrl.navy.mil, referencing Navy Case #212595.

### BACKGROUND

This invention relates generally to a new class of dye materials which become more acidic when exposed to light. In particular, the invention relates to compounds which are broadly classified as cyanine dyes, which contain within their structure a functional group with a labile proton such as a protonated nitrogen heterocycle.

Exposing the dye to light, either in the ultraviolet, visible, or near-infrared range, causes release of the proton into the local environment around the dye, while removing the light source causes regeneration of the dye in its protonated form.

This invention is designed to provide on-demand, external and reversible control of solution pH by manipulation of a light source in space and over time.

The ability to exert spatial and temporal control over a chemical reaction is of critical importance to a range of applications.

For example, in microelectronics fabrication, photolithography is used to create integrated circuits by chemically altering certain areas of a semiconductor chip to form intricate patterns on its surface which then dictate its function. A selective etching process is then performed to remove this material without impacting the surrounding area, thereby transferring the pattern to the surface of the chip permanently.

Another example is photodynamic therapy, where an external light source is used to induce a chemical reaction within the body to treat a medical condition non-invasively. Central to this technology is a dye molecule, often referred to as a photosensitizer, which absorbs the applied light in the ultraviolet, visible, or infrared range and converts it into chemical energy. The dye molecule is administered to a patient and allowed to reach a target region within the body, where this chemical energy is released to induce cell damage and kill target cells (eg. cancerous cells) non-invasively.

In both examples, light is used as an external stimulus for several reasons. First, spatial control is easily achieved by masking areas that should not undergo any reaction or through use of a focused light source such as a laser. Both approaches enable extremely precise patterns down to a few hundred nanometers in scale. Second, temporal control can be achieved by simply turning the light source on or off. Third, other properties of the light can be tuned to gain further control over the chemical process, such as the intensity and wavelength of light used. However, central to the success of this technology is the dye, which converts the light into chemical energy and dictates the nature of the chemical reaction that is performed.

This invention pertains to cyanine dyes, which are comprised of a polymethine chain terminated on one or both sides by a heteroatom or heterocyclic group.

Cyanine dyes are desirable for applications requiring a high degree of control due to the tunability of their photophysical and chemical properties. Their photophysical properties, such as wavelength and strength of light absorption, wavelength and strength of emission, excited state lifetime, and more, can be controlled by altering the chemical structure of the methine chain or the attached terminal groups. (See Bricks, J. L.; Kachkovskii, A. D.; Slominskii, Y. L.; Gerasov, A. O.; Popov, S. V. Dyes and Pigments 2015, 1212, 238-255; Feng, L.; Chen, W.; Ma, X.; Liu, S. H.; Yin, J. Organic and Biomolecular Chemistry 2020, 18, 9385-9397; both of which are incorporated herein by reference).

The chemical properties of these dyes can also be controlled through similar approaches, as well as by installation of various functional groups within the dye structure which promote interaction of the dye with certain other chemicals or substrates (eg. a specific analyte, DNA, or a specific cell type). This tunability has enabled the wide application of cyanine dyes in sensing, biomedical imaging, drug delivery, and photodynamic therapy. (See Zhou, H.-J.; Ren, T.-B. Chemistry—An Asian Journal 2022, 17, e202200147; Gorka, A. P.; Nani, R. R.; Schnermann, M. J. Accounts of Chemical Research 2018, 51, 3226-3235; Bilici, K.; Cetin, S.; Celikbas, E.; Acar, H. Y.; Kolemen, S. Frontiers in Chemistry 2021, 9, 707876; all of which are incorporated herein by reference).

More specifically, this invention relates to cyanine dyes that operate as photoacids.

Photoacids are molecules that contain an acid group which becomes more acidic when the molecule is exposed to light due to a lower pKₐ in the molecule's excited state (after light absorption) than its ground state (before light absorption). The lower pKₐ of the molecule's excited state allows it to undergo an excited state proton transfer, where it releases a proton into its local environment to a suitable proton acceptor.

In the absence of light, the molecule returns to its less acidic ground state (higher pKₐ) leading to the reverse proton transfer and regeneration of the original protonated dye molecule.

Two related classes of cyanine dyes have been previously described. The first is cyanine photoacids which contain an O—H acid group such as examples described in Karton-Lifshin, N.; Albertazzi, L.; Bendikov, M.; Baran, P. S.; Shabat, D. Journal of the American Chemical Society 2012, 134, 20412-20420; Karton-Lifshin, N.; Presiado, I.; Erez, Y.; Gepshtein, R.; Shabat, D.; Huppert, D. The Journal of Physical Chemistry A 2012, 116, 85-92; Simkovitch, R.; Kisin-Finfer, E.; Shomer, S.; Gepshtein, R.; Shabat, D.; Huppert, D. Journal of Photochemistry and Photobiology A: Chemistry 2013, 254, 45-53; Shabat, D.; Huppert, D. The Journal of Physical Chemistry A 2013, 117, 3405-3413; Green, O.; Simkovitch, R.; da Silva, L. P.; da Silva, J. C. G. E.; Shabat, D.; Huppert, D. The Journal of Physical Chemistry A 2016, 120, 6184-6199; Green, O.; Gajst, O.; Simkovitch, R.; Shabat, D.; Huppert, D. The Journal of Physical Chemistry A 2017, 121, 3079-3087; Kaiser, C.; Halbritter, T.; Heckel, A.; Wachtveitl, J. Chemistry—A European Journal 2021, 27, 9160-9173; Simkovitch, R.; Karton-Lifshin, N.; Shomer, S.; all of which are incorporated herein by reference. Notable examples include quinone cyanine dyes, which have been demonstrated to undergo reversible excited state proton transfers and possess excited state pKa* values around −6 to −8, which is comparable to strong mineral acids such as HCl. While some applications may warrant such strong acidities, not all processes are compatible with strong acids. In many cases, an excessively strong acid may promote unwanted reactions with other chemical species, leading to an overall degradation of the target material or environment. In addition, the O—H acid groups are often sufficiently acidic to dissociate even in the dark without activation by a light source, leading to partial deactivation of the photoacid and less precise control of the acid/base chemistry.

The second related class of dyes is cyanine photoacid generators, which are designed with a payload that is released upon exposing the dye to light. The payload can be tuned to a variety of chemical compositions depending on the intended application, including acidic groups to alter the pH of the local environment. Due to this tunability, the strength of the acid group can be modified and tailored to the requirements of a given application. For more sensitive applications, a mild acid group can be delivered to create moderate pH changes in the environment around the dye.

However, release of the payload is not reversible, meaning once the acidic payload has been delivered, the photoacid generator is permanently deactivated. Examples of cyanine photoacid generators are described in Dougherty, D. A.; Grubbs, R. H.; Clinton, J. R. International Pat. No. WO 2013/086460 A1, incorporated herein by reference.

The present invention discloses a new class of cyanine photoacids which contain an N—H acid group to produce a mild photoacid that is also reversible.

When the dye is exposed to light, the N—H bond breaks to release a proton into the local environment around the dye, causing a decrease in pH.

When the light is then removed, the N—H bond reforms, generating the original protonated dye that can be reused repeatedly and in a reversible fashion.

Due to the greater strength of the N—H bond relative to 0-H groups, the disclosed cyanine photoacid experiences a smaller change in pKₐ relative to previously reported cyanine photoacids, resulting in a more moderate pH change in the local environment.

In addition, the greater relative strength of the N—H bond minimizes its dissociation in the absence of light. This property increases the stability of the photoacid in the dark while providing the user with more precise control of the dye's acid/base chemistry by manipulating the light source. Similar molecules have been previously disclosed in He, L.; Lin, W.; Xu, Q.; Wei, H. ACS Applied Materials and Interfaces 2014, 24, 22326-22333, incorporated herein by reference.

Herein, we demonstrate a solution to these long-standing problems outlined above.

### SUMMARY OF DISCLOSURE

### Description

This invention relates to the preparation of new cyanine dye photoacid materials for external control of the pH of a solution or a local environment by manipulation of a light source.

According to a first aspect of the present invention, there is provided a cyanine dye with a nitrogen heterocycle within the methine chain, which contains at least one labile N—H bond, and terminal groups on either side of the methine chain, having the general structure:

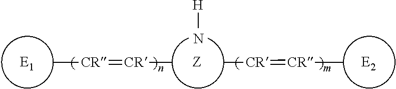

wherein E₁ and E₂ are substituted or unsubstituted heterocycles containing at least one heteroatom and one aromatic ring;
wherein R′ and R″ are independently selected from the group comprising hydrogen, alkyl, alkenyl, alkynyl, cycloalkyl, aryl, or halogen groups, or a combination thereof;
wherein Z is a substituted or unsubstituted heteroaromatic group in conjugation with the adjacent methine chains comprising one or more aromatic rings, and substituents independently selected from the group comprising H, alkyl, cycloalkyl, alkenyl, alkynyl, halogen, or aryl groups, or combinations thereof,
wherein n and m are integers independently selected from 0 to 4.

According to a second aspect of the invention, there is alternatively provided a cyanine dye with a nitrogen heterocycle on one end of the methine chain, which contains at least one labile N—H bond, and a terminal group on the other end of the methine chain, having the general structure:

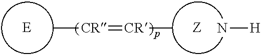

wherein E is a substituted or unsubstituted heterocycle;
wherein R′ and R″ are independently selected from the group comprising H, alkyl, cycloalkyl, alkenyl, alkynyl, halogen, or aryl groups, or combinations thereof;
wherein Z is a substituted or unsubstituted heteroaromatic group comprising one or more aromatic rings, and substituents independently selected from the group comprising H, alkyl, cycloalkyl, alkenyl, alkynyl, halogen, or aryl groups, or combinations thereof;
wherein n and m are an integer from 0 to 4.

According to a third aspect of the invention, there is provided a method of selectively and reversibly changing the pH of a solution or a local chemical environment by introducing the dye photoacid to the solution or environment and exposing it to light in the ultraviolet, visible, or infrared range.

### DESCRIPTION OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description when considered in conjunction with the drawings.

FIG. 1 illustrates a generalized structure of the photoacid, where R₁ and R₂ are heterocyclic structures referred to as the end groups used to tune the acidity of the N—H bond or the overall photophysical properties of the dye (e.g. absorption or emission wavelengths, excited state lifetime, etc.), and R₃ and R₄ are additional functional groups to tune the acidity of the N—H bond.

FIG. 2 illustrates an example structure of a photoacid.

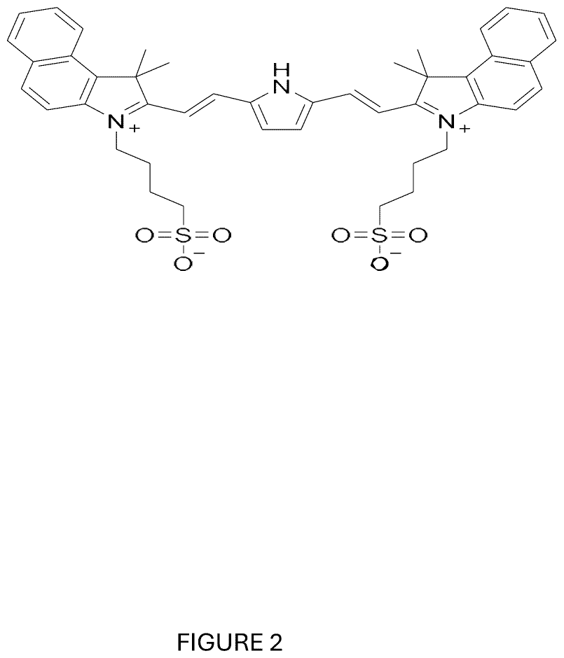

FIG. 3 illustrates an example synthesis of photoacid.

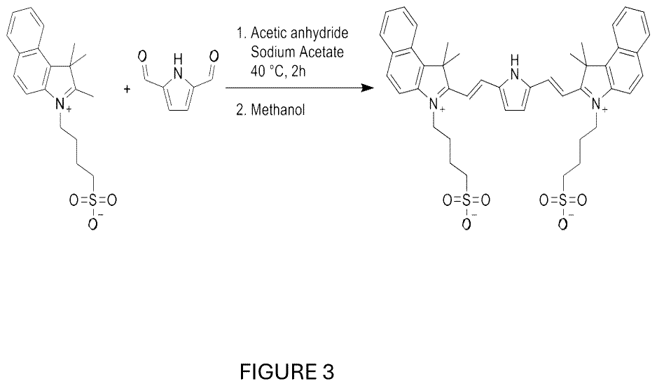

FIG. 4 illustrates absorption signal of a dye photoacid following periods of visible light irradiation and darkness.

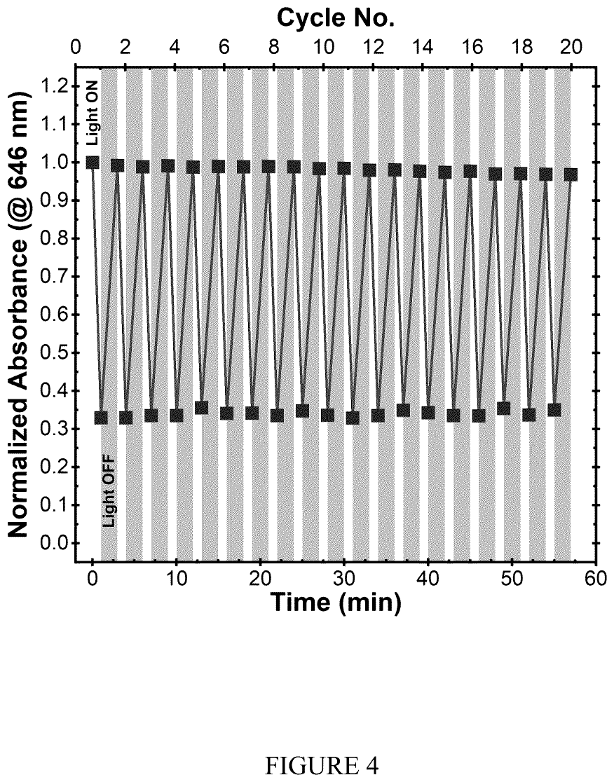

FIG. 5 illustrates the effect of a light source, which when turned on causes the solution pH to decrease.

### DETAILED DESCRIPTION OF THE INVENTION

The present invention relates to the preparation of new cyanine dye photoacid materials that can be used to control the pH of a solution or local environment by irradiation of the photoacid and manipulation of the light source.

Specifically, the present invention relates to cyanine dyes that contain a labile N—H bond, which becomes more acidic when the dye is absorbs light. While similar dye materials have been previously reported (He, L.; Lin, W.; Xu, Q.; Wei, H. ACS Applied Materials and Interfaces 2014, 24, 22326-22333, incorporated herein by reference), their design as photoacids and their use to control pH using light have not been previously disclosed.

One of the improved and novel features of the present invention is that it produces both a mild and reversible pH change when exposed to light.

The mild nature of the pH change results from the incorporation of N—H acid groups, which are less acidic than the acid groups typically incorporated into cyanine dye photoacids.

For sensitive applications where even small pH changes can have significant effects (eg. biological systems), the mild change in acidity afforded by the present invention can offer several advantages, including fewer unintended side reactions and minimal damage to the surrounding system.

In addition, the greater relative strength of the N—H bond increases the stability of the dye photoacid in the dark while also affording more precise control of pH by minimizing premature dissociation of the N—H bond.

The reversibility of the system stems from the mechanism through which the dye photoacid releases a proton into its local environment.

The dye photoacid exists in equilibrium between its protonated state and its dissociated state, consisting of the dye anion (the conjugate base) and the dissociated proton (H⁺). In the dark, this equilibrium favors the protonated dye, and effectively none of the dissociated state is present.

When the dye is exposed to light by constant irradiation, this equilibrium shifts towards the dissociated state, leading to greater release of the proton and accumulation of the dye anion in solution. The dye anion is stable under these conditions and persists until irradiation of the solution is ceased, at which time the equilibrium shifts back to its original state, causing the dye anion to react with H⁺ and regenerate the dye photoacid in its protonated form.

As a result, the acidity of the solution or local environment around the dye can be precisely controlled over time by turning the light source on and off, allowing pH to be increased or decreased repeatedly.

According to a first aspect of the present invention, there is provided a cyanine dye with a nitrogen heterocycle within the methine chain, which contains at least one labile N—H bond, and terminal groups on either side of the methine chain, having the general structure:

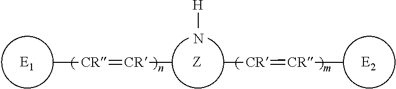

wherein E₁ and E₂ are substituted or unsubstituted heterocycles containing at least one heteroatom and one aromatic ring;
wherein R′ and R″ are independently selected from the group consisting of hydrogen, alkyl, alkenyl, alkynyl, cycloalkyl, aryl, or halogen groups, or a combination thereof,
wherein Z is a substituted or unsubstituted heteroaromatic group in conjugation with the adjacent methine chains consisting of one or more aromatic rings, and substituents independently selected from the group consisting of H, alkyl, cycloalkyl, alkenyl, alkynyl, halogen, and aryl groups, or combinations thereof;
wherein n and m are integers independently selected from 0 to 4.

In one embodiment, Z is a substituted or unsubstituted pyrrole. In another embodiment, R′ and R″ are hydrogen atoms. In another embodiment, n and m are both equal to 1. In yet another embodiment, the cyanine dye photoacid has the following general structure:

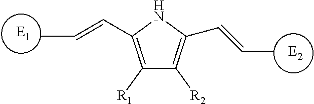

wherein R₁ and R₂ are independently selected from the group consisting of hydrogen, alkyl, aryl, cycloalkyl, halogen, or together form a cycloalkyl or aryl group.

In further embodiments, the pyrrole embedded in the methine chain of the dye photoacid (Z) has any of the following structures:

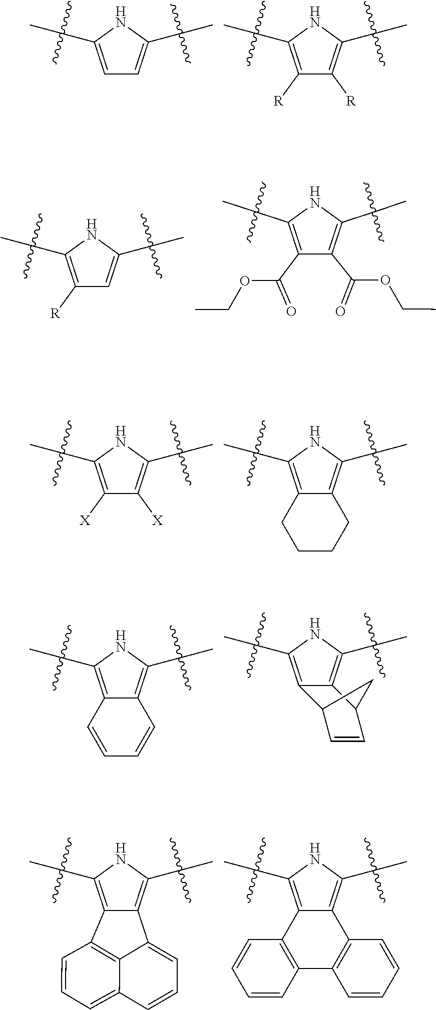

wherein R is an alkyl group and X is a halogen atom.

In yet other embodiments, the terminating functional groups E₁ and E₂ are substituted or unsubstituted indoliums, benzothiazoliums, or thiopyryliums which may either be identical or selected independently. In even further embodiments, E₁ and E₂ have any of the following structures:

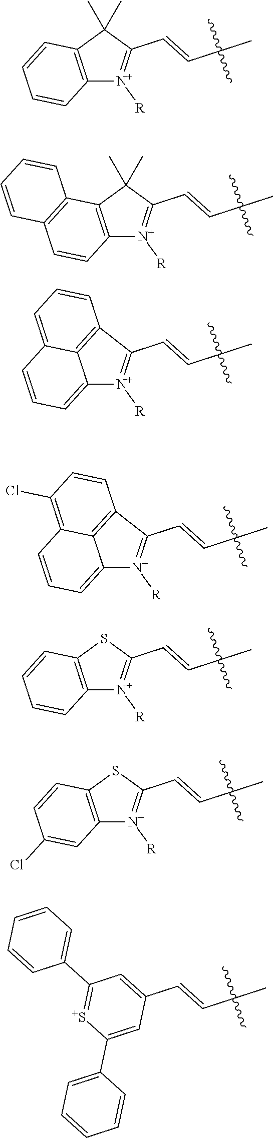

In an alternative embodiment, a cyanine dye photoacid can be prepared with a single terminating group such that is has the general structure:

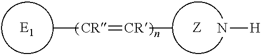

In further embodiments, E₁ and Z may have any of the structures described above for the embedded pyrroles or the terminating functional groups.

The compounds of the present invention can be synthesized by reacting a suitable mono- or di-aldehyde functionalized pyrrole starting material with another molecule containing an active methylene group such as an indolium, benzothiazolium, or thiopyrylium.

The reaction is carried out at 40° C. for several hours in the presence of a base, such as sodium acetate, resulting in the condensation of the aldehyde with the terminating groups and the release of water as a byproduct.

Once synthesized, the dye photoacid can be prepared as a solution by mixing with a solvent or combination of solvents. The solvent is chosen based on the given application with consideration for the solubility of the dye. In instances where the solubility of the dye is limited in a given solvent, a mixture of solvents may be used to improve its solubility.

The pH of the solution is modulated by irradiating the solution of the dye with a suitable light source. The wavelength of light should be selected by consulting the absorption spectrum of the dye photoacid and should presumably lie in the ultraviolet, visible, or infrared range of the spectrum. Where possible, selection of a wavelength that is strongly absorbed (eg. the wavelength of maximum absorption) should be considered to maximize the effect of the photoacid. Any light source can be used, such as an incandescent bulb, a fluorescent bulb, a light emitting diode, or a laser.

Where temporal control over pH is desired, the light source can be turned on and off to increase or decrease the pH of the solution on demand.

Where spatial control is desired, a photomask or a laser can be used to selectively irradiate certain areas and, therefore, limit the pH change to those areas.

### Example 1

### Preparation of the Photoacid

Acetic anhydride was degassed for 30 minutes by Ar bubbling. Meanwhile, 1,1,2-Trimethyl-3-(4-sulfobutyl)-1h-benz[e]indoliumhydroxide,innersalt (0.1780 g, 0.5153 mmol, 2 eq) and sodium acetate (0.0639 g, 0.779 mmol, 3 eq) were weighed into a 4 mL glass scintillation vial along with a magnetic stir bar and pumped into an Ar-filled glovebox. 1H-Pyrrole-2,5-dicarbaldehyde (0.0343 g, 0.279 mmol, 1 eq) was weighed into the vial, after which it was sealed with a septum cap.

The vial was removed from the glovebox, and the degassed acetic anhydride (0.97 mL, 10.3 mmol, 40 eq) was added to the reaction via syringe under Ar atmosphere. The reaction was immediately heated to 40° C. for 2.5 h with continuous stirring. During this time, the reaction solution turned dark blue in color.

After 2.5 h, the reaction products were dissolved in methanol and transferred into a glass centrifuge tube. The solution was concentrated using rotary evaporation and then precipitated into 40 mL diethyl ether. The suspension was centrifuged and decanted to collect the resulting solid and washed again with 40 mL fresh diethyl ether.

The solid product was collected again by centrifugation, dried, and then purified by normal-phase column chromatography on silica (dry loaded; solvent=DCM, then 95/5 DCM/MeOH, then 90/10 DCM/MeOH, then 70/30 DCM/MeOH, then MeOH) to yield a dark blue solid. Yield 0.1670 g (83.50%). ¹H NMR (400 MHz, DMSO-d₆): δ13.68 (s, 1H), 8.48 (d, 2H, J=15.9 Hz), 8.40 (d, 2H, J=8.5 Hz), 8.27 (d, 2H, J=8.9 Hz), 8.21 (d, 2H, J=8.3 Hz), 8.16 (d, 2H, J=8.9 Hz), 7.85 (d, 2H, J=16.4 Hz), 7.80 (t, 2H, J=7.9 Hz), 7.71 (t, 2H, J=7.5 Hz), 7.62 (s, 2H), 4.76 (t, 4H, J=6.6 Hz), 2.83 (t, 4H, J=5.1 Hz), 2.21-2.09 (bm, 4H), 2.04 (s, 12H), 2.00-1.94 (m, 4H). UV-Vis (methanol): l_{max,abs}=566, 601, 647. Fluorescence (methanol): l_{max,em}=680, 733.

### Example 2

### Control of Solution pH by Irradiation of the Photoacid

A portion of the dye photoacid was dissolved in a clear glass vial using a mixture of water with 10% by volume dimethylsulfoxide to improve the solubility of the dye.

Dissolution of the dye was assisted by ultrasonication, after which a magnetic stir bar was added to the solution, and it was placed on a magnetic stir plate. A fluorescence white light was placed next to the vial, approximately 1 cm from the side of the vessel.

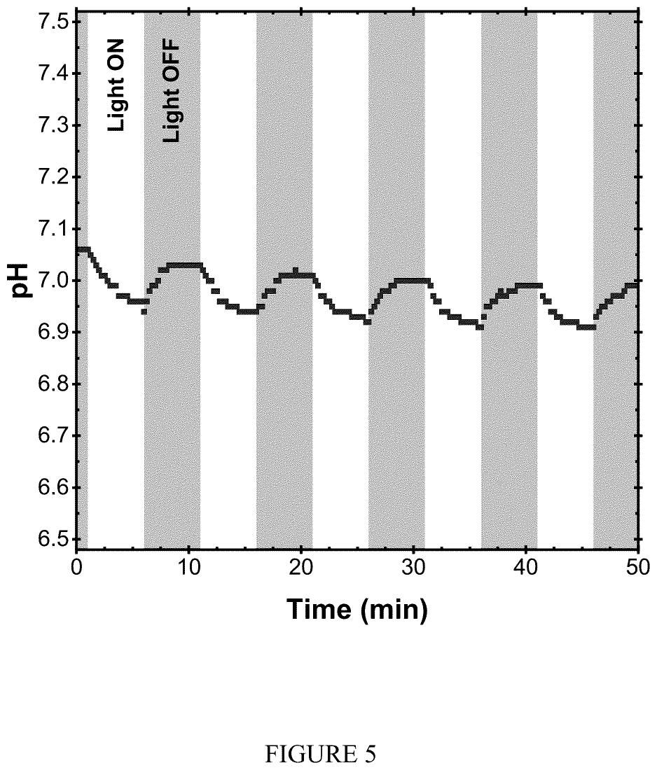

A digital pH probe was inserted into the solution to monitor solution pH as the light source was manipulated. FIG. 5 demonstrates the effect of the light source, which when turned on causes the solution pH to decrease.

When the light is turned off, the solution pH increases to approximately the original value prior to irradiation.

The cycle can be repeated several times, with the same effect produced each time demonstrating the reversibility of the pH change.

Other N—H containing heteroaromatic groups are also contemplated for group Z, such as imidazole, pyrazole, indole, or carbazole, as long as the N—H bond is part of the conjugated system.

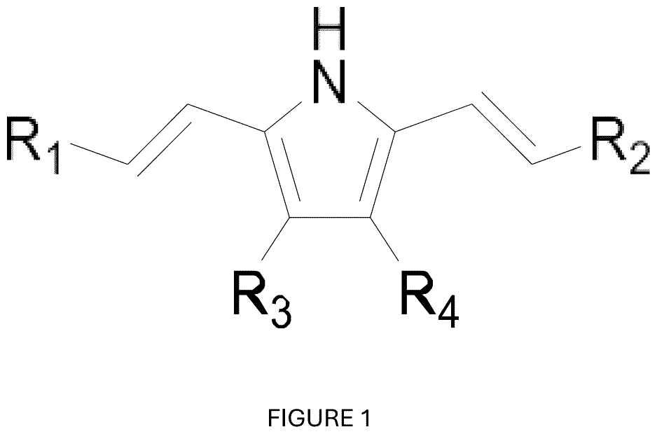

Any dye molecule with the basic structure described in FIG. 1, consisting of a protonated nitrogen-heterocycle in the methine bridge connected to heterocyclic end groups, can exhibit similar photoacid behavior.

The strength of the photoacid can be tuned by altering the identity of the protonated nitrogen-heterocycle in the methine bridge, and several examples of alternatives are shown.

Possible variations include the addition of alkyl or aromatic moieties, as well as electron donating or withdrawing groups to tune the strength of the N—H bond. A weaker N—H bond will produce a stronger photoacid, whereas a stronger N—H bond will produce a weaker photoacid.

### Advantages and New Features

Our disclosure demonstrates both the photoacid and the deprotonated dye are stable under ambient conditions, so the reaction is fully reversible.

Removing the light source alters the equilibrium of the acid-base reaction, allowing for the photoacid to regenerate entirely and in a short timeframe (minutes).

This process of deprotonation and protonation can be repeated through numerous cycles by simply turning the light source on and off, as demonstrated.

The strength of the UV-visible absorption signal produced by each species is consistent through several cycles, indicating both species are stable and form in similar quantities through successive cycles.

The above examples are merely illustrative of several possible embodiments of various aspects of the present disclosure, wherein equivalent alterations and/or modifications will occur to others skilled in the art upon reading and understanding this specification and the annexed drawings. In addition, although a particular feature of the disclosure can have been illustrated and/or described with respect to only one of several implementations, such feature can be combined with one or more other features of the other implementations as can be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

What we claim is:

1. A cyanine dye having the general structure: 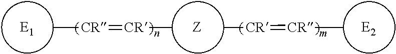
wherein E₁ and E₂ are substituted or unsubstituted heterocycles containing at least one heteroatom and one aromatic ring;
wherein R′ and R″ are independently selected from the group consisting of hydrogen, alkyl, alkenyl, alkynyl, cycloalkyl, aryl, and halogen groups, or a combination thereof,
wherein Z is a substituted or unsubstituted heteroaromatic group in conjugation with the adjacent methine chains consisting of one or more aromatic rings, and substituents independently selected from the group consisting of H, alkyl, cycloalkyl, alkenyl, alkynyl, halogen, and aryl groups, or combinations thereof,
wherein n and m are integers independently selected from 0 to 4; and
wherein E₁, E₂, or Z contains a group which can be reversibly removed and reattached by breaking and reforming a chemical bond.

2. The cyanine dye of claim 1 wherein Z contains a labile proton as the group which can be reversibly removed.

3. The cyanine dye of claim 2 wherein Z contains an N—H group in conjugation with —(CR″═CR′)—.

4. The cyanine dye of claim 3 wherein Z is a pyrrole group with the general structure: 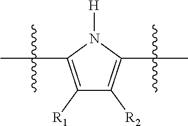
wherein R₁ and R₂ are independently selected from the group consisting of hydrogen, alkyl, aryl, cycloalkyl, and halogen, or together form a cycloalkyl or aryl group.

5. The cyanine dye of claim 4 wherein E₁ and E₂ have the general structure: 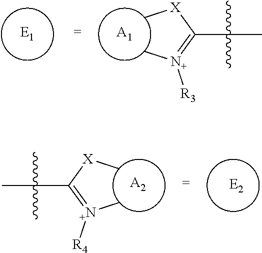
wherein X comprises CR₅R₆, NR₇, or S;
wherein R₃, R₄, R₅, R₆, and R₇ are independently selected from the group consisting of hydrogen, alkyl, alkenyl, alkynyl, cycloalkyl, aryl, or halogen groups, or a combination thereof;
wherein A₁ and A₂ are independently selected aryl groups.

6. The cyanine dye of claim 4 wherein E₁ and E₂ have the general structure: 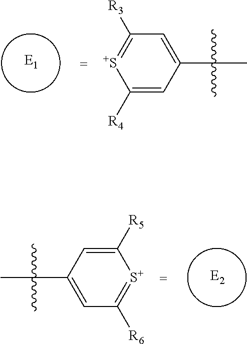
wherein R₃, R₄, R₅, and R₆ are independently selected from the group consisting of hydrogen, alkyl, alkenyl, alkynyl, cycloalkyl, aryl, or halogen groups, or a combination thereof.

7. The cyanine dye of claim 3 wherein the cyanine dye becomes more acidic when exposed to light.

8. A method for reversibly modulating the pH of a medium, the method comprising:
providing a cyanine dye according to claim 3 in said medium;
exposing said cyanine dye to light to induce the release of a proton and decrease the pH of the medium.

9. The method of claim 8, further comprising the steps of:
removing the light, thereby causing the cyanine dye to be re-protonated and increasing the pH of the medium.

10. The method of claim 8 where the light has a wavelength in the UV, visible, or near infrared range.

11. A cyanine dye having the general structure: 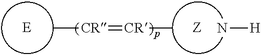
wherein E is a substituted or unsubstituted heterocycles containing at least one heteroatom and one aromatic ring;
wherein R′ and R″ are independently selected from the group consisting of hydrogen, alkyl, alkenyl, alkynyl, cycloalkyl, aryl, and halogen groups, or a combination thereof,
wherein Z is a substituted or unsubstituted heteroaromatic group in conjugation with the adjacent methine chain consisting of one or more aromatic rings, and substituents independently selected from the group consisting of H, alkyl, cycloalkyl, alkenyl, alkynyl, halogen, and aryl groups, or combinations thereof,
wherein p is an integer from 0 to 4; and
wherein E or Z contains a group which can be reversibly removed and reattached by breaking and reforming a chemical bond.

12. The cyanine dye of claim 11 wherein Z contains a labile proton as the group which can be reversibly removed.

13. The cyanine dye of claim 12 wherein Z contains an N—H group in conjugation with —(CR″═CR′)—.

14. The cyanine dye of claim 13 with the general structure: 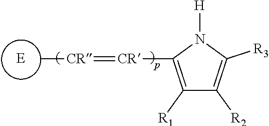
wherein R₁, R₂, R₃ are independently selected from the group consisting of hydrogen, alkyl, aryl, cycloalkyl, and halogen, or together in any combination form a cycloalkyl or aryl group.

15. The cyanine dye of claim 14 with the general structure: 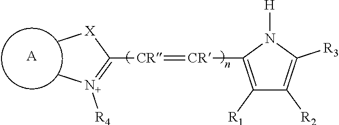
wherein X consists of CR₅R₆, NR₇, or S;
wherein R₄, R₅, R₆, and R₇ are independently selected from the group consisting of hydrogen, alkyl, alkenyl, alkynyl, cycloalkyl, aryl, and halogen groups, or a combination thereof, and
wherein A is an aryl group.

16. The cyanine dye of claim 14 with the general structure: 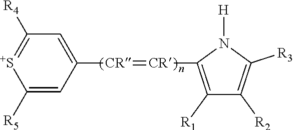
wherein R₄ and R₅ are independently selected from the group consisting of hydrogen, alkyl, alkenyl, alkynyl, cycloalkyl, aryl, and halogen groups, or a combination thereof.

17. The cyanine dye of claim 13 with the general structure: 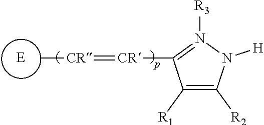
wherein R₁, R₂, R₃ are independently selected from the group consisting of hydrogen, alkyl, aryl, cycloalkyl, and halogen, or together in any combination form a cycloalkyl or aryl group.

18. The cyanine dye of claim 17 with the general structure: 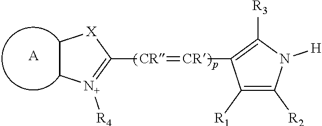
wherein X consists of CR₅R₆, NR₇, or S;
wherein R₄, R₅, R₆, and R₇ are independently selected from the group consisting of hydrogen, alkyl, alkenyl, alkynyl, cycloalkyl, aryl, and halogen groups, or a combination thereof, and
wherein A is an aryl group.

19. The cyanine dye of claim 17 with the general structure: 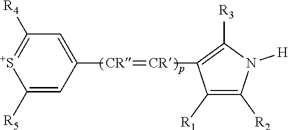
wherein R₄ and R₅ are independently selected from the group consisting of hydrogen, alkyl, alkenyl, alkynyl, cycloalkyl, aryl, and halogen groups, or a combination thereof.

20. The cyanine dye of claim 13 which becomes more acidic when exposed to light.

21. A method for reversibly modulating the pH of a medium, the method comprising:
providing a cyanine dye according to claim 13 in said medium;
exposing said cyanine dye to light to induce the release of a proton and decrease the pH of the medium.

22. The method of claim 21, further comprising the steps of:
removing the light, thereby causing the cyanine dye to be re-protonated and increasing the pH of the medium.

23. The method of claim 21 wherein the light has a wavelength in the UV, visible, or near infrared range.
